(19) United States
(12) Patent Application Publication
(10) Pub. No.: US 2025/0317749 A1
(43) Pub. Date: Oct. 9, 2025

(54) WIRELESS COMMUNICATION SYSTEM, CONTROL APPARATUS, PLACEMENT CONTROL METHOD, AND PROGRAM

(71) Applicant: NIPPON TELEGRAPH AND TELEPHONE CORPORATION, Tokyo (JP)

(72) Inventors: Toshiro NAKAHIRA, Tokyo (JP); Daisuke MURAYAMA, Tokyo (JP); Takeru FUKUSHIMA, Tokyo (JP); So TAKATANI, Tokyo (JP); Takatsune MORIYAMA, Tokyo (JP)

(21) Appl. No.: 18/865,830

(22) PCT Filed: Jul. 19, 2022
(86) PCT No.: PCT/JP2022/028116

§ 371 Date: Nov. 14, 2024

(51) Int. Cl. H04W 16/18

(52) U.S. Cl. CPC H04W 16/18

(57) ABSTRACT

In a wireless communication system including one or more base station devices that communicate with one or more terminal devices and a control apparatus, the control apparatus includes: a placement calculation unit that calculates a plurality of placement patterns in which a plurality of base station devices is placed in a target area; and a placement control unit that calculates, for each placement pattern, an evaluation index value based on a communication request of each terminal device, selects a placement pattern having a best evaluation index value, and performs placement control of the base station devices based on the selected placement pattern.

### TECHNICAL FIELD

The present invention relates to a technique of dynamically placing a base station device in a wireless communication system.

### BACKGROUND ART

In a wireless communication system, it is conceivable to uniformly place base station devices in an area in order to efficiently secure area coverage. However, in that case, it is conceivable that communication quality of a specific area deteriorates due to an influence of terminal congestion, shielding, and the like.

Meanwhile, there has been studied a technique of dynamically placing a movable base station device (base station device that is movable) in an area whose communication quality has deteriorated to improve the deterioration in the communication quality (Non Patent Literature 1).

### CITATION LIST

### Non Patent Literature

Non Patent Literature 1: Arai et al., “AMAP: Adaptive Movable Access Point System for Offloading Efficiency Enhancement”, IEICE Technical Report, vol. 116, no. 46, RCS2016-43, pp. 107-112, May 2016.

### SUMMARY OF INVENTION

### Technical Problem

However, in the conventional technique of dynamically placing a base station device which is disclosed in Non Patent Literature 1 or the like, the base station device is placed based on received power or an SNR of a terminal device. Therefore, in the conventional technique, it is difficult to satisfy a communication request of the terminal device in a case where, for example, a communication request different for each terminal device is generated.

The present invention has been made in view of the above points, and an object thereof is to provide a technique of placing a base station device in consideration of a communication request of each terminal device.

### Solution to Problem

The disclosed technique provides a wireless communication system including one or more base station devices that communicate with one or more terminal devices and a control apparatus, in which
the control apparatus includes
a placement calculation unit that calculates a plurality of placement patterns in which a plurality of base station devices is placed in a target area, and
a placement control unit that calculates, for each placement pattern, an evaluation index value based on a communication request of each terminal device, selects a placement pattern having a best evaluation index value, and performs placement control of the base station devices based on the selected placement pattern.

### Advantageous Effects of Invention

The disclosed technology provides a technique of placing a base station device in consideration of a communication request of each terminal device.

### BRIEF DESCRIPTION OF DRAWINGS

FIG. 1 illustrates an example of clustering.

FIG. 2 illustrates an overview of processing.

FIG. 3 is a flowchart illustrating an operation of a control apparatus.

FIG. 4 illustrates an example of a base station device placement pattern.

FIG. 5 illustrates an example of a base station device placement pattern.

FIG. 6 illustrates a method of calculating a communication request achievement rate.

FIG. 7 indicates an example of processing of selecting a base station device placement pattern.

FIG. 8 illustrates a device configuration example.

FIG. 9 illustrates a hardware configuration example of a device.

### DESCRIPTION OF EMBODIMENTS

Hereinafter, an embodiment (present embodiment) of the present invention will be described with reference to the drawings. The embodiment described below is merely an example, and embodiments to which the present invention is applied are not limited to the following embodiment.

### Overview of Embodiment

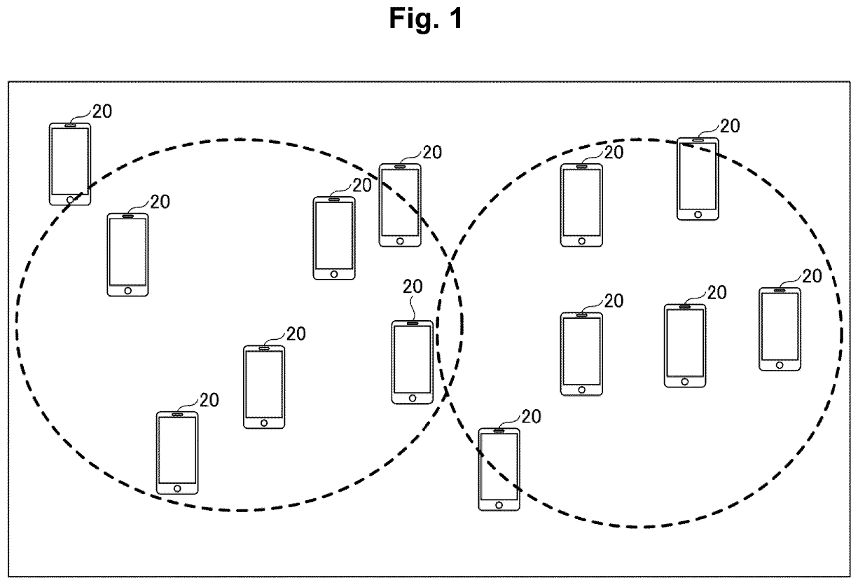

As a conventional technique of determining placement (position) of a base station device 10 to be a connection destination of a terminal device 20, as illustrated in FIG. 1, there is a technique of performing clustering on a plurality of terminal devices 20 and determining a position of the base station device based on received powers or SNRs of the terminal devices 20 in each cluster.

However, in the conventional technique, the base station device 10 is not placed in consideration of a communication request of each terminal device 20, and thus the communication request may not be satisfied in many terminal devices 20.

Therefore, in the present embodiment, the control apparatus 30 first prepares a plurality of base station device placement patterns. Specifically, for example, a plurality of placement patterns is generated by performing clustering a plurality of times while changing an initial value of the clustering. Then, the control apparatus 30 calculates, for each pattern, an evaluation index value (e.g. communication request achievement rate) based on a communication request of each communication terminal, selects a base station device placement pattern having the best evaluation index value, and places the base station device 10 in accordance with the base station device placement pattern. With such processing, it is possible to easily derive placement of the base station device 10 in consideration of the communication request of the terminal device 20. Hereinafter, the “base station device placement pattern” will also be referred to as a “placement pattern” or “pattern”.

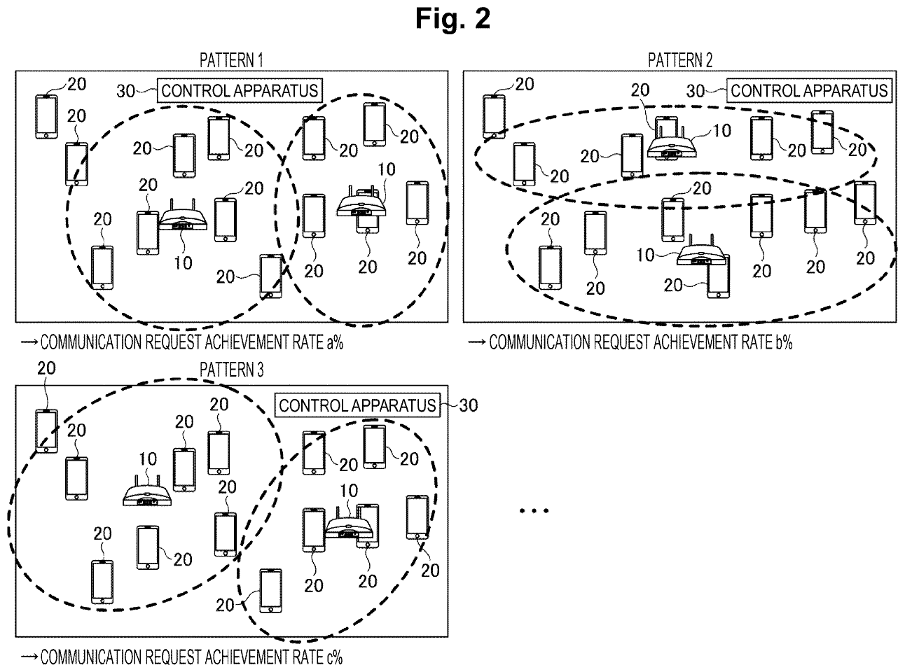

An overview of processing in a case of using the communication request achievement rate as the evaluation index value will be described with reference to FIG. 2. Note that the communication request achievement rate corresponds to a ratio of the number of terminal devices 20 that can satisfy a required communication quality when connected to the base station device 10 to the total number of terminal devices 20, and a method of calculating the ratio will be described later.

FIG. 2 illustrates three placement patterns. Any placement pattern indicates a system configuration in which one or a plurality of base station devices 10 and one or a plurality of terminal devices 20 exist in the present embodiment. The control apparatus 30 performs placement control.

The base station device 10 may be a base station device in a cellular communication network (e.g. 3G, 4G/LTE, 5G, or 6G), a base station device in a wireless LAN, or a base station device in a communication method other than those methods. The terminal device 20 can wirelessly communicate with one or a plurality of base station devices 10.

Each base station device 10 can move under the control of the control apparatus 30. The base station device 10 may be referred to as a movable base station device. Any means may be used for movement. For example, the movement may be implemented by mounting the base station device 10 on a drone, the base station device 10 may be movable on a rail by mounting the base station device 10 on the rail, the movement may be implemented by mounting the base station device 10 on a vehicle, or the movement may be implemented by other methods. Here, the “base station device 10” also includes moving means (placement control unit). The base station device 10 may be moved manually.

Among a plurality of base station devices 10 in a target area, a movable base station device 10 and a fixed base station device 10 may co-exist. Further, a plurality of different wireless systems (e.g. 5G and wireless LAN) may co-exist in a plurality of base station devices 10 to be controlled.

The control apparatus 30 may be connected to each base station device 10 in a wireless or wired manner. The control apparatus 30 may be provided in, for example, a core network of a mobile network, the Internet, or a network other than those networks.

A relay base station device 40 may be provided between the control apparatus 30 and the base station device 10. In this case, communication between the control apparatus 30 and the base station device 10 is performed via the relay base station device 40. In a case where a direction of an antenna included in the base station device 10 is variable, the control apparatus 30 can change the direction of the antenna included in the base station device 10.

A function of the control apparatus 30 may be provided in the base station device 10, the terminal device 20, or the relay base station device 40. The base station device 10, the terminal device 20, and the relay base station device 40 having the function of the control apparatus 30 all may be referred to as a “control apparatus”.

In the example of FIG. 2, the control apparatus 30 performs clustering on the plurality of terminal devices 20 while changing the initial value of the clustering, thereby generating the three base station device placement patterns of FIG. 2. The base station device 10 is placed at the center of gravity of the cluster, for example.

The control apparatus 30 calculates a communication request achievement rate for each pattern and selects a pattern having the highest (best) communication request achievement rate. In the example of FIG. 2, the communication request achievement rate of a pattern 1 is a %, the communication request achievement rate of a pattern 2 is b %, and the communication request achievement rate of a pattern 3 is c %. In a case where a is the highest among a, b, and c, the control apparatus 30 selects the pattern 1 from the three patterns and performs control to place (move) the base station device 10 at a position of each base station device 10 in the pattern 1.

Evaluation of the pattern may be performed in consideration of a direction of link, such as an uplink or downlink, and capability information of each terminal device.

### Operation Example of System

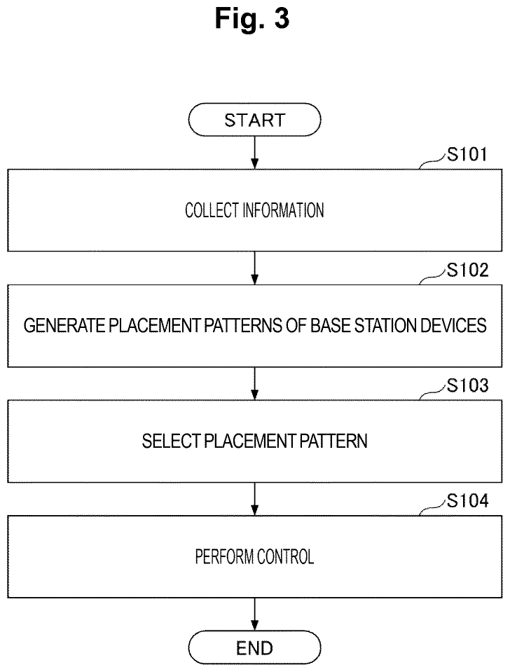

Next, an operation of the control apparatus 30 will be described along a procedure of the flowchart of FIG. 3. In the operation described below, it is assumed that there is an area that the control apparatus 30 is in charge of (referred to as a target area) and that the terminal device 20 and the base station device 10 in the target area are targets to be controlled. One or a plurality of terminal devices 20 and one or a plurality of base station devices 10 exist in the target area.

Regarding communication between the base station device 10 and the terminal device 20 in the present embodiment, only a downlink may be considered, only an uplink may be considered, or both the downlink and the uplink may be considered. For example, a “throughput of the terminal device 20” may be a downlink throughput in the terminal device 20, an uplink throughput in the terminal device 20, or a total throughput of the downlink throughput and the uplink throughput in the terminal device 20.

In an operation example described below, it is assumed that the antenna of the base station device 10 is an omnidirectional antenna. In a case where the antenna of the base station device 10 is an antenna having directivity (in a case of an antenna that can change a direction), for example, it is only necessary to calculate the evaluation index value (e.g. communication request achievement rate) in a case where the antenna is faced in a direction in which the evaluation index value becomes best in the following calculation of the evaluation index value.

Control of the procedure described below may be periodically performed, may be performed in response to an instruction from a system administrator, or may be performed at other timings.

### <S101>

In S101, the control apparatus 30 acquires a position (position information) of each terminal device 20. The position of the terminal device 20 may be acquired by any method. For example, a positioning technique standardized in 3GPP may be used to acquire the position. The control apparatus 30 acquires a communication request (e.g. communication request throughput) of each terminal device 20. The communication request may be acquired by any method.

### <S102>

In S102, the control apparatus 30 calculates a plurality of placement patterns in which a plurality of base station devices 10 is placed in a target area.

Specifically, for example, the control apparatus 30 first performs clustering processing on the plurality of terminal devices 20 in the target area and divides the plurality of terminal devices 20 into a plurality of clusters (terminal clusters). Such clustering processing is performed a plurality of times (e.g. a predetermined number of times).

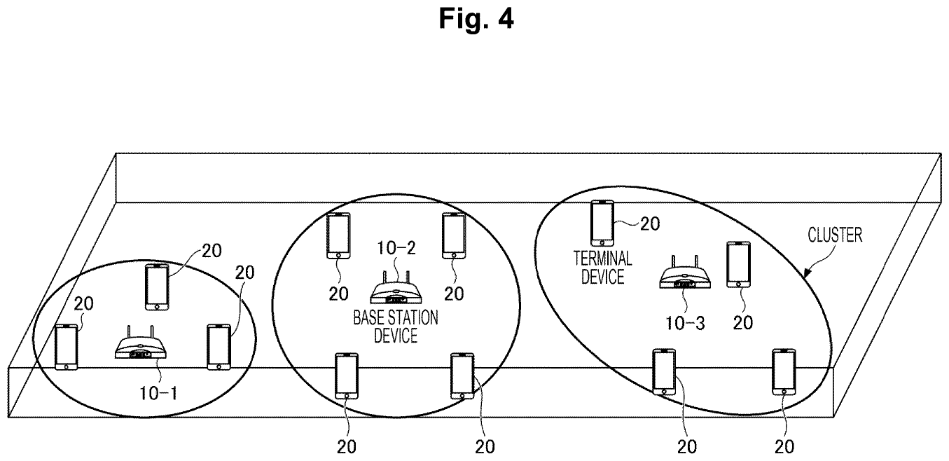

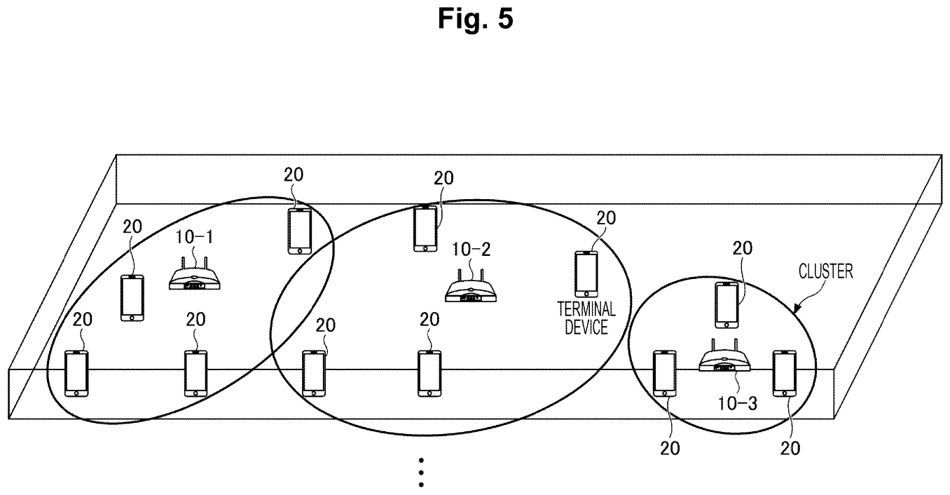

The base station device 10 is placed at the center of gravity of each of the plurality of clusters generated in each clustering. A pattern in which the base station device 10 is placed in each of the plurality of clusters generated in one clustering is a base station device placement pattern. As an example of a placement image, FIG. 4 illustrates a certain base station device placement pattern, and FIG. 5 illustrates another base station device placement pattern.

Any method may be used as the clustering method, and, for example, k-means method or hierarchical clustering can be used.

As an example, the control apparatus 30 randomly changes a clustering initial value and performs clustering on the plurality of terminal devices 20 in the target area by the k-means method. Specifically, for example, the clustering initial value of the number (denoted as M) of base station devices 10 in the target area is set, and the plurality of terminal devices 20 are divided into M clusters. Such clustering processing is performed a plurality of times while the clustering initial value is randomly changed.

In the above example, a plurality of base station device placement patterns is generated by performing clustering a predetermined number of times using different initial values, but the method of generating a base station device placement pattern is not limited to this method.

For example, placement of the base station devices 10 prepared in advance may be used as the base station device placement pattern, a pattern in which the base station devices 10 are randomly placed may be used as the base station device placement pattern, the base station device placement pattern may be prepared by other methods, or the base station device placement pattern prepared by any one of those methods and the base station device placement pattern generated by clustering may be combined.

In the above example, the base station device 10 is placed at the center of gravity of the terminal cluster, but the method of placing the base station device 10 in the terminal cluster is not limited to this method. For example, a possible placement position satisfying a predetermined condition may be selected from a plurality of possible placement positions in the terminal cluster, and the base station device 10 may be placed at the selected position. For example, the base station device 10 may be placed at a position where the number of terminal devices 20 that can see the base station device 10 is maximum in the area of the terminal cluster.

### <S103>

In S103, the control apparatus 30 calculates the evaluation index value (e.g. communication request achievement rate) for each base station device placement pattern, selects a base station device placement pattern having the best evaluation index value from the plurality of base station device placement patterns, and determines the pattern as a placement pattern of the base station devices 10. Details of the processing in a case of using the communication request achievement rate as the evaluation index value will be described later.

### <S104>

In S104, the control apparatus 30 performs control to move each base station device 10 such that the base station device 10 is placed at a position of each base station device 10 in the placement pattern determined in S103. Further, for each terminal cluster, the control apparatus 30 performs control to connect each terminal device 20 in the terminal cluster to the base station device 10 of the terminal cluster. Any method may be used as the control method here.

For example, in a case where a certain terminal device 20 transmits a connection request to the control apparatus 30 via a certain base station device 10, the control apparatus 30 issues, to the terminal device 20 that has transmitted the connection request, an instruction specifying the base station device 10 to which the terminal device 20 is to be connected. The terminal device 20 transmits a connection request to the base station device 10 as instructed by the control apparatus 30.

### Details of Processing in S103

Here, the processing in S103 by the control apparatus 30 in a case where the communication request achievement rate is calculated as the evaluation index value will be described in detail.

The control apparatus 30 calculates the communication request achievement rate by the following procedures (S1 to S4) and selects a placement pattern. In the following procedure, the control apparatus 30 has already collected a communication request throughput of each terminal device 20.

### S1:

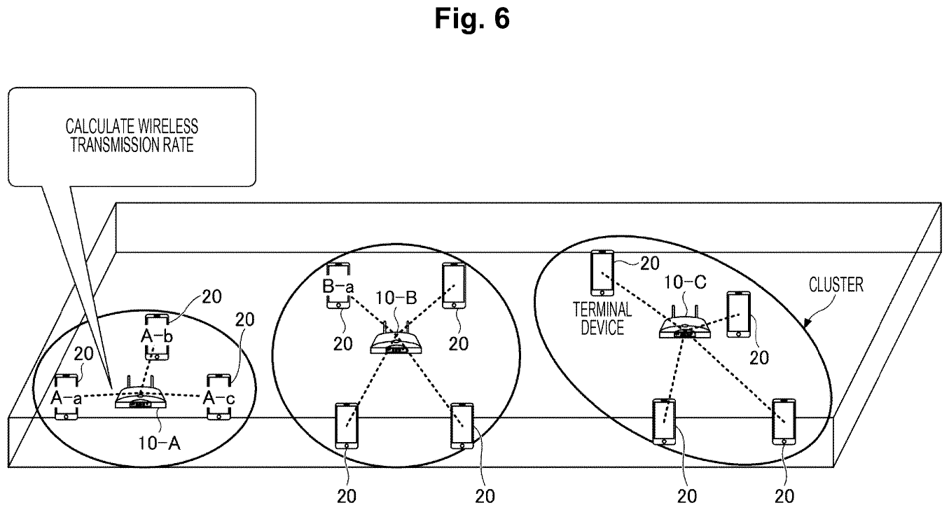

The control apparatus 30 calculates (estimates) a wireless transmission rate between each terminal device 20 and the base station device 10 to be a connection destination (i.e. the base station device 10 placed in the cluster to which the terminal device 20 belongs). The wireless transmission rate can be calculated from, for example, an estimated value of received power in the terminal device 20. A calculation image of the wireless transmission rate is illustrated in FIG. 6. Note that a “base station device 10-A” and the like in FIG. 6 will also be referred to as a “base station device A” and the like in the following description.

### S2:

The control apparatus 30 divides the communication request throughput by the wireless transmission rate calculated in S1 for each terminal device 20 to be connected to the base station device 10 and calculates a communication resource use rate (base station communication resource use rate) of the base station device 10.

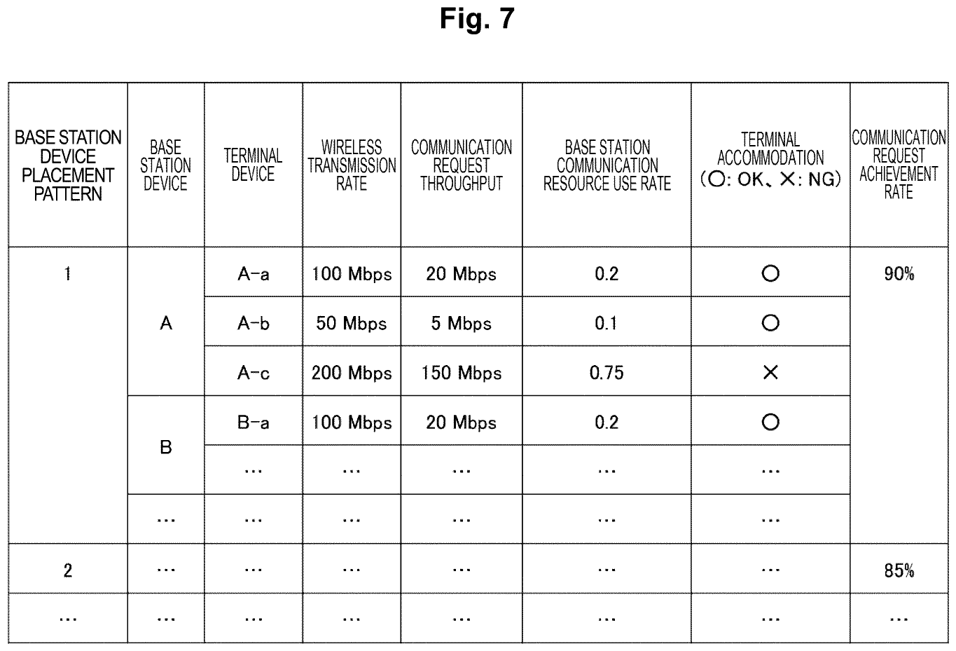

FIG. 7 indicates a specific example. FIG. 7 indicates a calculation example and the like of the base station communication resource use rate for each base station device placement pattern, for each base station device, and for each terminal device. The control apparatus 30 holds information indicated in FIG. 7 in a storage device (e.g. DB 34 described later) by performing the calculation.

In the example of FIG. 7, for example, a terminal device A-a belonging to the base station device A of the base station device placement pattern 1 has the wireless transmission rate of 100 Mbps and the communication request throughput of 20 Mbps, and thus the base station communication resource use rate is calculated as 0.2.

### S3:

The control apparatus 30 accommodates the terminal devices 20 in the base station device 10 in ascending order of the base station communication resource use rate and terminates terminal accommodation processing on the base station device 10 at a point of time when a total base station communication resource use rate of the accommodated terminal devices 20 exceeds 1.

For example, regarding terminal devices belonging to the base station device A of the base station device placement pattern 1 in FIG. 7, the control apparatus 30 accommodates a terminal device A-b and the terminal device A-a in the base station device 10 in this order and attempts to accommodate a terminal device A-c in the base station device 10. If the terminal device A-c is accommodated therein, the total base station communication resource use rate exceeds 1, and thus the terminal accommodation processing is terminated at a point of time when the terminal device A-a is accommodated. At this time, the accommodated terminal devices are the terminal device A-b and the terminal device A-a as indicated in FIG. 7.

### S4:

The control apparatus 30 calculates a ratio of the number of accommodated terminal devices 20 to the number of all terminal devices 20 in the target area for each base station device placement pattern and sets the ratio as the communication request achievement rate. The control apparatus 30 selects a base station placement pattern having the highest communication request achievement rate.

In the example of FIG. 7, the communication request achievement rate of the base station device placement pattern 1 is 90%, and the communication request achievement rate of the base station device placement pattern 2 is 85%. If those two patterns are all patterns, the control apparatus 30 selects the base station device placement pattern 1.

In the above example, the communication request throughput of the terminal device 20 can be grasped by the control apparatus 30, and the calculation of the communication request achievement rate using a value of the communication request throughput has been described.

However, placement control can be performed even in a case where the communication request throughput of the terminal device 20 cannot be grasped by the control apparatus 30. In this case, for example, the control apparatus 30 assumes the communication request throughput of each terminal device 20 as a constant value and calculates the communication request achievement rate on that assumption. Even in a case where the assumption is used, it is possible to perform placement control assumed to easily satisfy the communication request throughput as much as possible.

In the above example, the terminal devices 20 are accommodated in the corresponding base station device 10 in ascending order of the base station communication resource use rate, but the accommodation method is not limited to this method. For example, an accommodation priority may be given to the terminal devices 20, and a terminal device 20 having a high priority may be preferentially accommodated.

For example, regarding the terminal devices belonging to the base station device A of the base station device placement pattern 1 of FIG. 7, it is assumed that the order of the priority is the terminal device A-c>the terminal device A-b>the terminal device A-a. At this time, the control apparatus 30 accommodates the terminal device A-c and the terminal device A-b in the base station device 10 in this order and attempts to accommodate the terminal device A-a in the base station device 10. If the terminal device A-a is accommodated therein, the total base station communication resource use rate exceeds 1, and thus the terminal accommodation processing is terminated at a point of time when the terminal device A-b is accommodated. At this time, the accommodated terminal devices are the terminal device A-b and the terminal device A-c.

### Other Examples

Using the communication request achievement rate as the evaluation index used to select the base station device placement pattern is an example. An evaluation index other than the communication request achievement rate may be used.

For example, as the evaluation index used to select the base station device placement pattern, a degree of satisfaction of communication to a user of the terminal device 20, QoE of the user of the terminal device 20, or the like may be used as the evaluation index, or a plurality of evaluation indexes may be used in combination.

Both the degree of satisfaction and QoE described above can be estimated from, for example, a communication delay, throughput, and the like estimated in the terminal device 20.

For example, in a case where QoE is used as the evaluation index, the evaluation index in a certain base station device placement pattern may be an average of QoE in all the target terminal devices 20 or may be a ratio of the number of terminal devices 20 that satisfy QoE (or predetermined QoE) required in the terminal devices 20 to all the target terminal devices 20.

As described above, the movable base station device 10 and the fixed base station device 10 may co-exist in the target area. In this case, for example, the control apparatus 30 excludes in advance the terminal devices 20 accommodated in the fixed base station device 10 and calculates placement of the movable base station device 10 with respect to the terminal devices 20 remaining in the target area by the method described above.

### Device Configuration Example

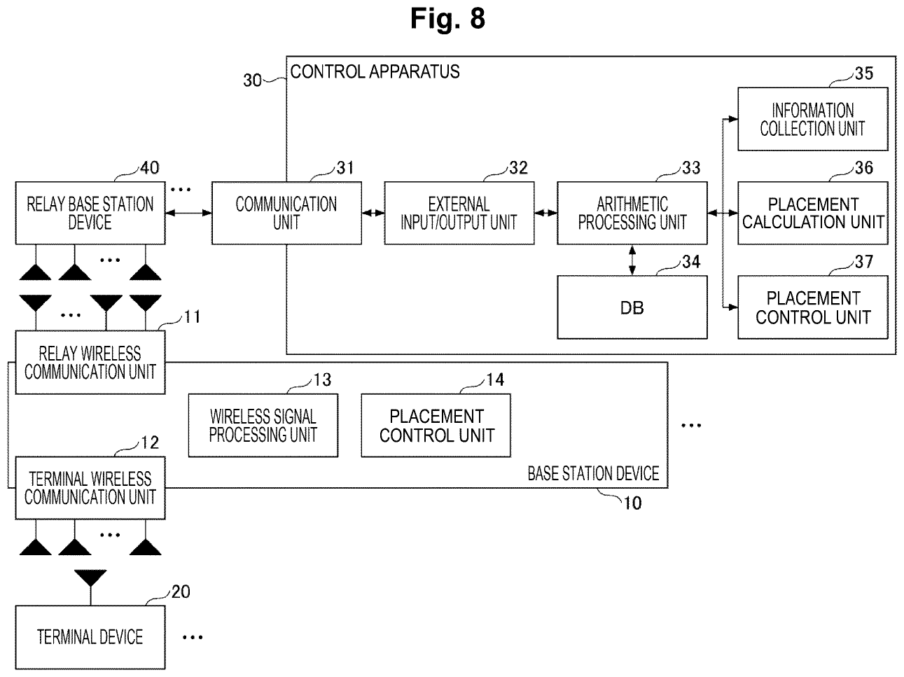

Next, a device configuration example of a device forming the wireless communication system will be described with reference to FIG. 8. FIG. 8 illustrates a device configuration particularly related to connection control in detail. Further, FIG. 8 illustrates an example where the relay base station device 40 relays communication between the base station device 10 and the control apparatus 30.

As illustrated in FIG. 8, the control apparatus 30 includes a communication unit 31, an external input/output unit 32, an arithmetic processing unit 33, a database (DB) 34, an information collection unit 35, a placement calculation unit 36, and a placement control unit 37.

The communication unit 31 is connected to a network to perform information communication. The external input/output unit 32 passes information received via the communication unit 31 to the arithmetic processing unit 33 and outputs information received from the arithmetic processing unit 33 to the outside via the communication unit 31.

The arithmetic processing unit 33 stores information in the DB 34 and reads information from the DB 34, for example.

The information collection unit 35 acquires information from the outside via the communication unit 31, the external input/output unit 32, and the like. For example, the information collection unit 35 acquires a position, a communication request (including, for example, a communication request throughput, a required degree of satisfaction, and required QoE), and the like of each terminal device 20. The acquired information is stored in the DB 34 and is read and used by the placement calculation unit 36 and the placement control unit 37.

As described in S102 and the like of the flowchart of FIG. 3, the placement calculation unit 36 calculates a plurality of placement patterns in which the plurality of base station devices 10 is placed in the target area. A placement result is stored in the DB 34 and is read and used by the placement control unit 37.

As described in S103 and the like of the flowchart of FIG. 3, the placement control unit 37 calculates the evaluation index value based on a communication request of each terminal device 20 for each placement pattern, selects a placement pattern having the best evaluation index value, and performs placement control of the base station devices 10 based on the selected placement pattern. In the process of the selection of the placement pattern and the placement control, the placement control unit 37 stores the information of the table of FIG. 7 in the DB 34 and accesses the DB 34 to perform the calculation.

The above placement control includes, for example, at least one control among movement control for moving the base station device 10 to a position in the selected placement pattern and connection control for connecting each terminal device 20 belonging to the moved base station device 10 to the base station device 10. Note that the movement control includes not only control for causing the placement control unit 14 to move the base station device 10, but also notifying, a terminal of an administrator (person) of the base station device 10, of a destination position of the base station device 10. In this case, for example, the administrator (person) manually moves the base station device 10.

The base station device 10 includes a relay wireless communication unit 11, a terminal wireless communication unit 12, a wireless signal processing unit 13, and a placement control unit 14. The relay wireless communication unit 11 communicates with the control apparatus 30 via the relay base station device 40. The terminal wireless communication unit 12 wirelessly communicates with the terminal device 20. The wireless signal processing unit 14 performs, for example, conversion processing between a wireless signal and data.

The wireless signal processing unit 14 performs control for accommodating the terminal device 20, for example, receives a connection request from the terminal device 20 and returns a response signal to the terminal device 20. The wireless signal processing unit 14 also performs control to transmit the connection request received from the terminal device 20 to the control apparatus 30 and return information of the connection destination base station device 10 received from the control apparatus 30 to the terminal device 20.

The placement control unit 14 moves the base station device 10 to a desired position in response to an instruction from the placement control unit 37 of the control apparatus 30.

### Hardware Configuration Example

The terminal device 20, the base station device 10, the control apparatus 30, and the relay base station device 40 can all be implemented by, for example, causing a computer to execute a program. The computer may be a physical computer or may be a virtual machine on a cloud. Hereinafter, “the terminal device 20, the base station device 10, the control apparatus 30, and the relay base station device 40” will be collectively referred to as a “device”.

That is, the device can be implemented by executing a program corresponding to processing performed by the device by using hardware resources, such as a CPU and a memory built in the computer. The above program can be stored and distributed by being recorded in a computer-readable recording medium (e.g. portable memory). Further, the above program can also be provided through a network, such as the Internet or an electronic mail.

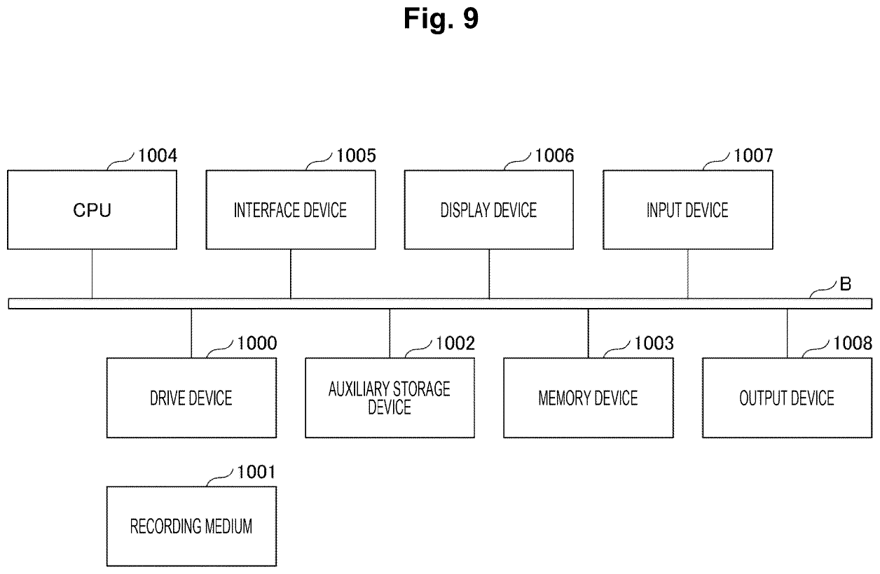

FIG. 9 illustrates a hardware configuration example of the above computer. The computer in FIG. 9 includes a drive device 1000, an auxiliary storage device 1002, a memory device 1003, a CPU 1004, an interface device 1005, a display device 1006, an input device 1007, an output device 1008, and the like which are connected to each other via a bus BS.

The program for implementing processing in the computer is provided through, for example, a recording medium 1001, such as a CD-ROM or a memory card. When the recording medium 1001 storing the program is set in the drive device 1000, the program is installed on the auxiliary storage device 1002 from the recording medium 1001 via the drive device 1000. However, the program is not necessarily installed from the recording medium 1001 and may be downloaded from another computer via a network. The auxiliary storage device 1002 stores the installed program and also stores necessary files, data, and the like.

In a case where an instruction to start the program is made, the memory device 1003 reads the program from the auxiliary storage device 1002 and stores the program. The CPU 1004 implements a function related to the device in accordance with the program stored in the memory device 1003.

The interface device 1005 is used as an interface for connection to a network or the like. The display device 1006 displays a graphical user interface (GUI) or the like according to the program. The input device 1007 includes a keyboard and a mouse, a button, a touchscreen, and the like and is used to input various operation instructions. The output device 1008 outputs calculation results.

Note that the device is not required to include any one or a plurality or all of the display device 1006, the input device 1007, and the output device 1008.

### Summary and Effects of Embodiment

As described above, according to the technique of the present embodiment, it is possible to easily derive dynamic placement of the base station device 10 in consideration of a communication request of each terminal device 20.

### Supplementary Notes

The present specification discloses at least a wireless communication system, a control apparatus, a placement control method, and a program in the following items.

### (Supplementary Note 1)

A wireless communication system including one or more base station devices that communicate with one or more terminal devices and a control apparatus, in which
the control apparatus includes
a placement calculation unit that calculates a plurality of placement patterns in which a plurality of base station devices is placed in a target area, and
a placement control unit that calculates, for each placement pattern, an evaluation index value based on a communication request of each terminal device, selects a placement pattern having a best evaluation index value, and performs placement control of the base station devices based on the selected placement pattern.

### (Supplementary Note 2)

The wireless communication system according to supplementary note 1, in which
in the calculation of each placement pattern, the placement calculation unit performs clustering on a plurality of terminal devices, divides the plurality of terminal devices into a plurality of clusters, and places the base station device at a position of a center of gravity of each cluster.

### (Supplementary Note 3)

The wireless communication system according to supplementary note 1 or 2, in which
the placement control unit uses, as the evaluation index value, at least one of a communication request achievement rate, a degree of satisfaction to a user of the terminal device, or QoE of the user of the terminal device.

### (Supplementary Note 4)

A control apparatus in a wireless communication system including one or more base station devices that communicate with one or more terminal devices and the control apparatus, the control apparatus including:
a memory; and
at least one processor connected to the memory, in which
the processor
calculates a plurality of placement patterns in which a plurality of base station devices is placed in a target area, and
calculates, for each placement pattern, an evaluation index value based on a communication request of each terminal device, selects a placement pattern having a best evaluation index value, and performs placement control of the base station devices based on the selected placement pattern.

### (Supplementary Note 5)

A placement control method in a wireless communication system including one or more base station devices that communicate with one or more terminal devices and a control apparatus, in which:
the control apparatus calculates a plurality of placement patterns in which a plurality of base station devices is placed in a target area; and
the control apparatus calculates, for each placement pattern, an evaluation index value based on a communication request of each terminal device, selects a placement pattern having a best evaluation index value, and performs placement control of the base station devices based on the selected placement pattern.

### (Supplementary Note 6)

A non-transitory storage medium storing a program for causing a computer to function as each unit of the control apparatus according to supplementary note 4.

While the present embodiments have been described above, the present invention is not limited to such specific embodiments, and various modifications and changes can be made within the scope of the spirit of the present invention described in the claims.

### Reference Signs List

10 Base station device
11 Relay wireless communication unit
12 Terminal wireless communication unit
13 Wireless signal processing unit
14 Placement control unit
20 Terminal device
30 Control apparatus
31 Communication unit
32 External input/output unit
33 Arithmetic processing unit
34 DB
35 Information collection unit
36 Placement calculation unit
37 Placement control unit
40 Relay base station device
1000 Drive device
1001 Recording medium
1002 Auxiliary storage device
1003 Memory device
1004 CPU
1005 Interface device
1006 Display device
1007 Input device
1008 Output device

1. A wireless communication system comprising a plurality of base station devices configured to communicate with a plurality of terminal devices, and a control apparatus, wherein
the control apparatus includes:
a processor; and
a memory storing program instructions that cause the processor to:
calculate a plurality of placement patterns in which the plurality of base station devices is placed in a target area, and
calculate, for each of the plurality of placement patterns, an evaluation index value based on a communication request of each of the plurality of terminal devices, select a placement pattern having a best evaluation index value, and perform placement control of the plurality of base station devices based on the selected placement pattern.

2. The wireless communication system according to claim 1, wherein
in the calculation of each of the plurality of placement patterns, the program instructions cause the processor to perform clustering on the plurality of terminal devices, divide the plurality of terminal devices into a plurality of clusters, and place a corresponding base station device among the plurality of base station devices at a position of a center of gravity of each cluster.

3. The wireless communication system according to claim 1, wherein
the program instructions cause the processor to use, as the evaluation index value, at least one of a communication request achievement rate, a degree of satisfaction to a user of each of the plurality of terminal devices, or quality of experience (QoE) of the user of each of the plurality of terminal devices the terminal device.

4. A control apparatus in a wireless communication system including a plurality of base station devices configured to communicate with a plurality of terminal devices, and the control apparatus, the control apparatus comprising:
a processor; and
a memory storing program instructions that cause the processor to:
calculate a plurality of placement patterns in which the plurality of base station devices is placed in a target area; and
calculate, for each of the plurality of placement patterns, an evaluation index value based on a communication request of each of the plurality of terminal devices, select a placement pattern having a best evaluation index value, and perform placement control of the plurality of base station devices based on the selected placement pattern.

5. A placement control method in a wireless communication system including a plurality of base station devices configured to communicate with a plurality of terminal devices, and a control apparatus, the placement control method comprising:
calculating, by the control apparatus, a plurality of placement patterns in which the plurality of base station devices is placed in a target area; and
calculating, by the control apparatus, for each of the plurality of placement patterns, an evaluation index value based on a communication request of each of the plurality of terminal devices, selecting a placement pattern having a best evaluation index value, and performing placement control of the plurality of base station devices based on the selected placement pattern.

6. A non-transitory computer-readable recording medium having stored therein a program for causing a computer to perform the placement control method according to claim 5.
